(19) United States
(12) Patent Application Publication
(10) Pub. No.: US 2006/0090068 A1
(43) Pub. Date: Apr. 27, 2006

(54) Method for separating ip packets which can be allocated to specific groups and corresponding ip packet

(75) Inventors: Frank-Uwe Andersen, Berlin (DE); Uwe Foll, Falkensee (DE)

Correspondence Address: MORRISON & FOERSTER LLP, 1650 TYSONS BOULEVARD, SUITE 300, MCLEAN, VA, 22102, US

(73) Assignee: SIEMENS AKTIENGESELLSCHAFT, Munchen (DE)

(21) Appl. No.: 10/546,710

(22) PCT Filed: Feb. 25, 2003
(86) PCT No.: PCT/DE03/00712

§ 371 Date: Aug. 24, 2005

(51) Int. Cl. H04L 9/00

(52) U.S. Cl. 713/160

(57) ABSTRACT

The invention relates to a method for separating IP packets which can be allocated to specific groups in a packet-based mobile radio network. All IP packets entering into the mobile radio network are tested in a first authorized network element of the mobile radio network with respect to allocation to at least one group. A group-specific marking is produced, at least for IP packets which can be allocated to a specific group, in a field of a header of at least one packet, especially one of said IP packets.

### CLAIM FOR PRIORITY

This application is a national stage application PCT/DE2003/000712, which was published on Sep. 10, 2004, and was filed on Feb. 25, 2003.

### TECHNICAL FIELD OF THE INVENTION

The present invention relates to a method for separating IP packets which can be associated with specific groups and to an IP packet.

### BACKGROUND OF THE INVENTION

In wireless and wired communication networks, communication methods are frequently used which are based on the transmission of data packets (e.g. IP packets, IP=Internet Protocol). These are then referred to as packet-based mobile radio networks. Such IP packets comprise a header (header part) and a data container which follows the header. The design of such a header is described, by way of example, in the printed document “Network Working Group, Request for comments 2460, Internet Protocol, Version 6 (IPv6) Specification” by S. Deering and R. Hinden dated December 1998, particularly in Section 3 “IPv6 Header Format”. The header and the data container form the IP packet. The header stores data which are required for transmitting the IP packet from an IP packet sender to an IP packet receiver. In packet-based mobile radio networks, charge detection is based, inter alia, on detection of the transmitted IP packets. In this case, the charges are calculated from the total volume of the IP packets transmitted from and to a user. An IP packet stream, particularly when the IPv6 version is used, contains not only pure useful data from applications, however, but also internal signaling data, such as for (stateless) configuration or segmentation (MY discovery). The signaling IP packets transmitted are transmitted within a tunnel by network elements in the mobile radio network. In this case, they are transmitted within the same tunnels as the useful IP packets. The signaling IP packets therefore cannot readily be distinguished or separated from the useful IP packets. As a result, the users in question are burdened with bulk charge detection, as described beforehand, for these IP packets even though they are not transporting any actual useful data. Rather, the signaling IP packets serve the demands and needs of the network operator and have no relevance to the subscriber. In the extreme case, no application software is running either. In the case of what are known as “always-on” sessions, for example, IP packets are transmitted which contain IPv6 signaling parameters such as router addresses, that is to say IP packet switching. Even when a user is not using any kind of services, such as web access, these IP packets are detected within the context of charge detection and are billed to the user.

In addition, a plurality of applications can use an IP packet stream for transmitting their data. Particularly when free of charge data are transmitted by a specific application, the simultaneous use of an IP packet stream by a plurality of applications results in the problem of how to distinguish or separate the data.

In addition, it is possible that an operator might wish, in particular cases, to provide a user with arbitrary services, that is to say not with particular individual applications but rather with complete PDP contexts for arbitrary data transmissions, free of charge. In this case too, the problem arises of separating the IP packets associated with these PDP contexts from the other IP packets.

### SUMMARY OF THE INVENTION

The present invention provides a method and an IP packet which can be used in reliable and inexpensive fashion to separate IP packets which can be associated with specific groups.

In one embodiment of the invention, there is a method for separating IP packets which can be associated with specific groups in a packet-based mobile radio network, in which a first authorized network element in the mobile radio network checks IP packets arriving in the mobile radio network for associatability with at least one group, and at least IP packets which can be associated with a specific group have group-specific marking carried out for them in a field of a header in at least one, particularly in each, of these IP packets. In this context, it is particularly advantageous that the marking is made in a field of the respective header which is provided for holding transmitted data.

In one aspect of the invention, a field of the respective header is used whose field elements are taken up incompletely by transmitted data provided for transmitting the IP packet. As a result, appropriate use can advantageously be made of “unused” field elements. This concerns those field elements of the respective header which are not or not fully needed, during transmission, for holding transmitted data but which are nevertheless transmitted concomitantly, possibly filled with “zeros”.

In the invention, an IP packet is preferably used which is designed on the basis of stipulations from Internet Protocol Version 6 (IPv6).

Advantageously, the field used in the respective header may be the “Flow Label” field. This field is often not required for storing transmitted data, which means that the field elements in this field are not in use and provide space for a marking.

Similarly, the field used in the respective header may advantageously be the “Interface ID” field of an address field of the respective header in the IP packet. The “Interface ID” field of an address field of the header is often dimensioned to be of such a size that not all field elements (bits or bytes) are required for holding the Interface ID information. This allows the invention to use the unused bits or bytes for marking.

In addition, an additional IPv6 header may advantageously be defined which holds the marking. This additional header is then called an “extension header”. There are currently a plurality of extension headers defined in IPv6. Within the context of the present invention, it is also possible to take an existing extension header, for example of type “hop-by-hop option header”, and to structure its contents by providing it with a preceding description of the actual content; in the field of information technology, this is referred to as TLV (type, length, value).

In another aspect of the invention, the marking on a first authorized network element in the mobile radio network is written or made in the field of the respective header, the first network element being arranged between a transmitter-end IP stack and a receiver-end IP stack on a data channel. As a result, for devices which have access to the data channel, such as for exchanges belonging to an operator of the data channel or for an application computer, it advantageously becomes possible to provide IP packets transported via this data channel with a marking.

In one preferred embodiment of the invention, the marking of the IP packets is recognized by at least one second authorized network element, and the corresponding IP packets are subjected to a specific treatment.

Preferably, the second authorized network element is a charge detection point and the marked IP packets are recognized as being free of charge. The complexity for isolating or separating and marking the cost-related packets from the non-cost-related packets in the first authorized network element only is much lower than making the distinction or recognition in all network elements which are able to produce “charge tickets”. If signaling packets for which charging is not intended are involved, for example, direct IP-packet-based charging simplifies the operations significantly as a result of the separation of IP packets which have been recognized once as signaling packets and hence marked, since with n network elements, for example, n−1 times classification and separation are saved. In line with the invention, the remaining network elements which produce “charge data records” (charging tickets) need to look out only for the presence of a marking and then possibly to detect no charge data (charging ticket) for this packet. If a provider wishes to provide an application free of charge, the invention involves the IP packets which need to be associated with this application being marked by an appropriate application computer in the first authorized network element. This marking is then evaluated by the charge detection points, and the marked IP packets are recognized as free of charge. In this case too, the complexity for isolating or separating and marking the cost-related IP packets from the non-cost-related IP packets in just one network element is much lower than making the distinction or separation in all network elements which produce charge data records. For this purpose, these network elements would need to have a database containing free-of-charge applications or a database containing the destination and source addresses of the applications.

In addition, there is also the possibility that an operator might wish in certain cases to provide his customers with services free of charge. In this case, these are then not particular individual applications on particular TCP-UDP ports within existing PDP contexts, for example, but rather complete, free-of-charge PDP contexts for arbitrary IP data transmissions. In line with the invention, IP packets which are to be associated with this PDP context can now be marked by an application server. IP packets to be associated with this PDP context are thus recognized by the charge detection points and are not assigned a charge.

In a further preferred embodiment of the invention, a security function which erases the marking in marked IP packets arriving in the mobile radio network is introduced at boundary elements in the mobile radio network which are to be passed through by the IP packets and between which the authorized network elements of the mobile radio network are situated.

This has the advantage that any security risks can be avoided at the boundaries of the mobile radio network and on a terminal. When transmitting IP packets, there can be starting points for misuse at the network boundary of the mobile radio network through which it is intended to pass and on the terminal. For this purpose, an attacker could provide IP packets with a marking which identifies the IP packets as being free of charge. The charge detection points would not include the IP packets in the charge detection and the attacker could transmit data free of charge. In line with the invention, this risk is now anticipated by introducing a security function, which erases the marking in marked IP packets arriving in the mobile radio network, at the mobile radio network's boundary elements for which the IP packets to be transmitted are intended to pass through or at another point before the charge detection points. By way of example, the boundary elements are an RNC (Radio Network Controller) or a gateway computer (Gateway) to the mobile packet network. Using this security function, unauthorized use of the marking is prevented. The boundary elements in the mobile radio network into which the security function is introduced are chosen in this context such that network elements on the far side of these boundary elements have no use for a marking, that is to say that there is no charge detection and no authorized use of a marking in this case. Consequently, marking IP packets which pass through the network elements on the far side of the boundary elements carrying the security function has no effect on charge detection. The charge detection points in the mobile radio network and also the network elements authorized to introduce a marking are situated between the boundary elements carrying the security function. By introducing the security function, marking of an IP packet passing through the charge detection point is authorized and has not arisen through misuse.

In one preferred embodiment of the invention, the security function uses a bit mask. The use of a bit mask, such as addition of a zero bit mask to a byte with a set bit, is a very simple method which can be used to erase the marking used for separation. The security function is a simple function which has no greater power requirements and does not burden the mobile radio network. No databases or complex assessment methods are required. The security function can be integrated into existing network elements of the mobile radio network without difficulty and results only in a very small burden on the performance of the network elements.

In a further preferred embodiment of the invention, a function for evaluating the marking of the arriving IP packets and an indicator corresponding to the evaluation are provided in a reception-end terminal.

When using markings, for example to signal free-of-charge transmission in IP packets, it is desirable to indicate to a user the number of IP packets transmitted free of charge, for example. One aim of such an indication may be to make it clear to the user that no charges arise for transmitting the IP packets in line with the use of a particular service. In addition, the user needs to have the total volume of IP packets received free of charge indicated to him. Preferably, the function provided for evaluation in the reception-end terminal places a bit mask over an incoming IP packet, which makes it possible to assess whether the IP packet has been transmitted masked, that is to say free of charge, for example. By summing on a counter, it is possible to accumulate the total volume of IP packets transmitted free of charge. A suitable indicator function can access this counter.

The present invention also relates to an IP packet with a header and a data container, the IP packet being able to be associated with a specific group of IP packets, and a group-specific marking being entered in a field of the header.

In one preferred embodiment of the inventive IP packet, the field of the header is a field whose field elements are taken up incompletely by transmitted data provided for transmitting the IP packet.

In addition, the inventive IP packet is preferably designed on the basis of IPv6 stipulations.

Preferably, the IP packet is in a form such that the marking indicates that the IP packet is free of charge.

### BRIED DESCRIPTION OF THE DRAWINGS

Further advantageous embodiments of the invention are explained in more detail with reference to the following figures, in which:

FIG. 1 shows an IP infrastructure to explain a cycle of an embodiment of the invention.

FIG. 2 shows an IP infrastructure to explain a further cycle of another embodiment of the inventive method.

### DEATILED DESCRIPTION OF THE INVENTION

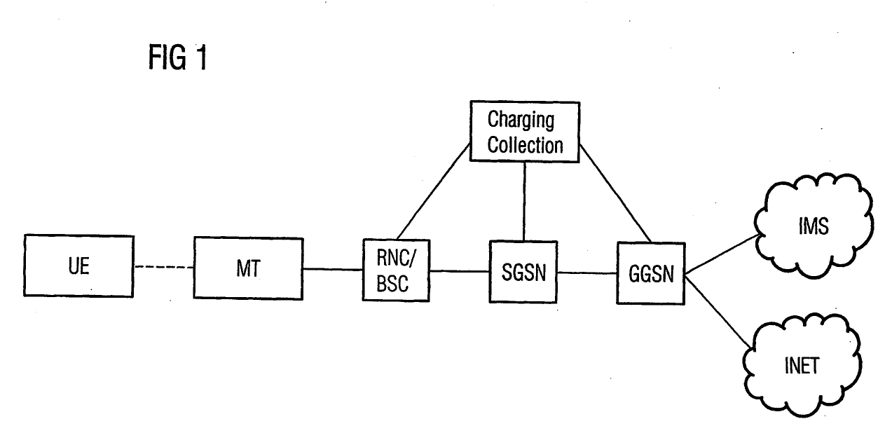

FIG. 1 shows detail of an IP infrastructure. It shows a piece of “user equipment” UE, which is connected to a mobile terminal MT. This mobile terminal MT provides the user equipment with access to a mobile radio network MF. Of the mobile radio network MF, only the network elements which are relevant within the context of this illustration have been shown. In this exemplary embodiment, a third-generation mobile radio network is shown which operates on the basis of GPRS stipulations (GPRS=General Packet Radio System). It shows an RNC (Radio Network Controller) or a BSC (Base Station Controller), which forms an access node. The RNC routes IP packets which are to be transmitted to an SGSN (Servicing GPRS Support Node). The SGSN is a control network node which controls the mobility of a mobile terminal. From the SGSN, the IP packets are then routed to a GGSN (Gateway GPRS Support Node). The GGSN is a central gateway in a GPRS network, which gateway in the present case ensures a link to a data packet control system IMS (IMS=IP Multimedia Subsystem) or to a packet data network, such as the Internet. If it is now necessary to send, by way of example, IP packets, which are designed on the basis of the stipulations of IPv6 and accordingly have a header and a data container, from the Internet or the IMS to the user equipment UE, with pure signaling packets needing to be transmitted free of charge, for example, then the IP packets first need to be checked to determine whether they are transporting pure signaling data. The GGSN now checks the IP packets arriving at it from the Internet or the IMS. If an IP packet includes only signaling data, the GGSN as first authorized network element in the mobile radio network puts a marking in a field of the header. This marking now signals to subsequent network elements through which the IP packet will pass that this IP packet is being transmitted free of charge. Both the SGSN and RNC may be used as charge detection points and may accordingly issue “charge data records”. In addition, they are able, that is to say authorized, to evaluate the marking and to recognize the IP packet as being free of charge. In this context, the marking is advantageously put in a field of the header in the IP packet whose field elements are taken up incompletely by transmitted data provided for transmitting the respective IP packet. In this case, the IP packet is designed on the basis of IPv6 stipulations. The marking can now be inserted in the “Flow Label” field, for example. It is also conceivable for the marking to be made in the “Interface ID” field. The latter is often proportioned to be of such a size that not all field elements are required for holding the interface ID information. As a result, the invention can use the unused bits or bytes for inserting the marking. In addition, it is conceivable to define an additional IPv6 header, an “extension header”, and to make the marking therein. If the aim is now to mark signaling packets, then these first of all need to be recognized as such. To this end, it is possible to perform “pattern matching” for the header of an IP packet with masks of known signaling packet types, for example. The recognition of an IP packet as signaling packet is invalid if the respective packet has been produced in this particular network element in which, in the subsequent step, the marking is then also made at once.

A further opportunity for application of the invention may also be a type of packet-based emergency call, for example. If a user addresses a possible IMS emergency application server with an IPv6-based emergency call using a PDP context, this application server marks the corresponding IP packets to be associated with the particular PDP context such that they are recognized as being free of charge by the charge detection points when the marking is evaluated. This prevents an emergency call from being terminated on account of a possible lack of credit.

A further opportunity for application of the invention may also be a free service for updating operating system programs (Firmware) on a mobile radio telephone, for example. If a user updates the operating system by addressing a possible application server with an IPv6-based update request using a PDP context, the application server makes a marking, in line with the invention, in the respective headers of the corresponding IP packets which are to be associated with the PDP context in question such that these IP packets are recognized as being free of charge by the charge detection points when the marking is evaluated. This makes it possible for an operator of a mobile radio network to fulfill its obligations for updating and restoring the terminals it sells without the user being charged for this.

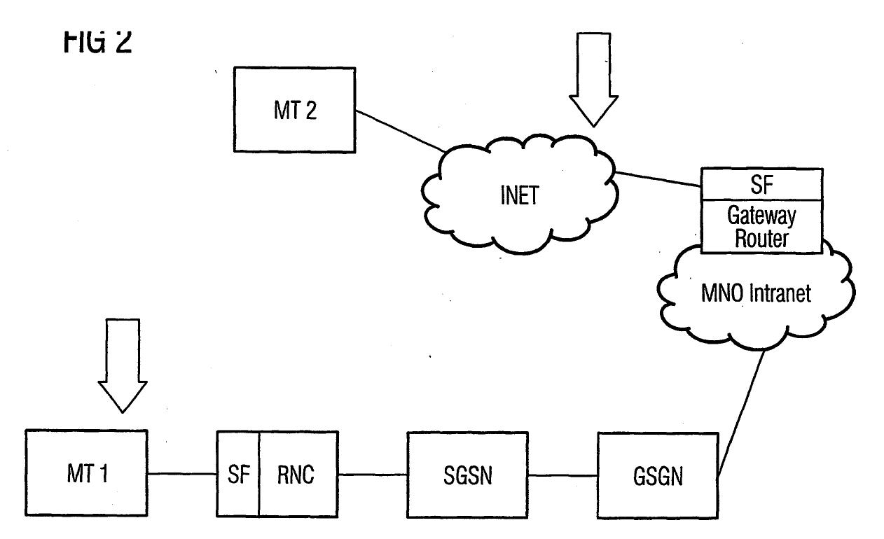

FIG. 2 also shows detail of an IP infrastructure. It shows two mobile terminals MT1, MT2. These mobile terminals MT1 and MT2 are connected to one another via a mobile radio network and the Internet (INET). For the mobile radio network, only a few relevant network elements have been shown. An RNC is used to provide the mobile terminal MT1 with access to the mobile radio network. In addition, an SGSN is shown as a control network node, and a GGSN, which ensures access to an MNO (Mobile Network Operator) intranet which is shown here. A gateway in the intranet allows access to the Internet INET. Finally, the Internet allows a connection to the second mobile terminal MT2. To transmit IP packets, IP version 6, i.e. IPv6, is used in the present example. When the invention is used, the signaling packets need to be provided with a marking in this case so that they are evaluated by the charge detection points and the corresponding IP packets are recognized as being free of charge and are treated as appropriate. At the network boundaries and at the mobile terminals, there may now be potential starting points for misuse. For this purpose, an attacker could provide IP packets with a specific marking which is evaluated by the charge detection points, and the appropriate IP packets are recognized as being free of charge. As a consequence, the charge detection points as authorized network elements would not include these IP packets in the charge detection, and the attacker would be able to transmit data free of charge. At two relevant boundary elements between which the authorized network elements in the mobile radio network are situated, a security function is now introduced which erases the marking in marked IP packets arriving in the mobile radio network. In the present case, the relevant boundary elements used are the RNC and a gateway in the MNO intranet. In these boundary elements of the mobile radio network, a security function SF is introduced. This function SF has the task of preventing unauthorized use of the marking. The two boundary elements RNC and gateway are chosen such that network elements on the far side of these boundary elements have no authorization to use the marking. Network elements on this side of the boundary elements can use the marking and are also not also adversely affected by the introduction of the security function in the boundary elements. The security function, for its part, is advantageously a simple method for erasing the marking in IP packets which pass through the security function or through the corresponding boundary elements. For the purposes of erasure, it is possible to use a simple bit mask, for example. Since IP packets passing through the security function are masked, there is no need for complex assessment methods. The security function in this form can be integrated in each gateway. In addition, it has no greater power requirements and does not burden the mobile radio network. No databases are required.

1. A method for separating IP packets which can be associated with specific groups in a packet-based mobile radio network, comprising:
checking IP packets arriving in the mobile radio network for compatibility with at least one group; and
performing a group-specific marking on at least IP packets which are associated with a specific one of the at least one group in a field of a header in at least one of the IP packets.

2. The method as claimed in claim 1,
wherein a respective field of respective headers is used whose field elements are taken up incompletely by data provided for transmitting the respective IP packet.

3. The method as claimed in claim 1, wherein IP packets are used which are designed on based on IPv6 stipulations.

4. The method as claimed in claim 1, wherein the field used in the respective headers is the “Flow Label” field.

5. The method as claimed in claim 1, wherein the field used in the respective headers is the “Interface ID” field.

6. The method as claimed in claim 1, wherein the field used in the respective headers is the “extension header” field.

7. The method claimed in claim 1, wherein the first authorized network element is arranged between a transmitter-end IP stack and a receiver-end IP stack on a data channel.

8. The method as claimed in claim 1, wherein the specific group is IP packets which can be associated with one and the same PDP context.

9. The method as claimed in claim 1 wherein the marking of the IP packets is recognized by a second authorized network element, and appropriate IP packets are subjected to specific treatment.

10. The method as claimed in claim 1, wherein when an IP packet passes through the first authorized network element a first marking is performed such that all other IP packets which can be associated with the same group can be recognized by the second authorized network element as being associated with the same group.

11. The method as claimed in claim 9, wherein the second authorized network element is a charge detection point and the marked IP packets are recognized as free of charge.

12. The method as claimed in claim 9 wherein a security function which erases the marking in marked IP packets arriving in the mobile radio network is introduced at boundary elements in the mobile radio network which are passed through by the IP packets and between which the authorized network elements of the mobile radio network are situated.

13. The method as claimed in claim 12,
wherein the security function uses a bit mask.

14. The method as claimed in claim 12, wherein a function for evaluating the marking of the arriving IP packets and an indicator corresponding to the evaluation are provided in a reception-end terminal.

15. An IP packet having a header and a data container, wherein
the IP packet is configured to be associated with a specific group of IP packets, and a group-specific marking is entered in a field of the header.

16. The IP packet as claimed in claim 15,
wherein the field of the header is a field whose field elements are taken up incompletely by data provided for transmitting the IP packet.

17. The IP packet as claimed in claim 15,
wherein the IP packet is designed based on IPv6 stipulations.

18. The IP packet as claimed in claim 15, wherein the marking indicates that the IP packet is free of charge.

19. A system for separating IP packets which can be associated with specific groups in a packet-based mobile radio network, comprising:
a first authorized network element in the mobile radio network to check IP packets arriving in the mobile radio network for compatibility with at least one group; and
at least one IP packet configured to be associated with a specific group having group-specific marking carried out in a field of a header in at least one of the IP packets.
